(19) United States
(12) Patent Application Publication
(10) Pub. No.: US 2013/0185810 A1
(43) Pub. Date: Jul. 18, 2013

(54) CONTROLLED SERIALIZATION AND/OR DESERIALIZATION

(71) Applicants: Sean Andrew Suchter, Los Altos Hills, CA (US); Eric Wai Ho Lau, Mountain View, CA (US); Yuri Romanenko, Redwood City, CA (US); Adam Sapek, Redmond, WA (US)

(72) Inventors: Sean Andrew Suchter, Los Altos Hills, CA (US); Eric Wai Ho Lau, Mountain View, CA (US); Yuri Romanenko, Redwood City, CA (US); Adam Sapek, Redmond, WA (US)

(73) Assignee: Microsoft Corporation, Redmond, WA (US)

(21) Appl. No.: 13/350,379

(22) Filed: Jan. 13, 2012

(51) Int. Cl. G06F 21/24

(52) U.S. Cl. 726/29

(57) ABSTRACT

Among other things, one or more techniques and/or systems are provided for controlling the serialization of data into a serialized structure and/or the deserialization of data from the serialized structure. That is, a first client may request serialization of data comprising one or more entities. Entities that the first client has permission to serialize may be serialized for inclusion within a serialized structure, which may be encrypted. A set of deserialization permissions specifying which entities may be accessed by which clients may be defined for the serialized structure. In this way, one or more entities within the serialized structure may be deserialized for a second client based upon evaluating the second client against the set of deserialization permissions to determine which entities the second client has permission to access. The serialized structure may otherwise remain encrypted to provide sustained protection of serialized data comprised therein.

### BACKGROUND

Today, many applications and services may convert data, such as a data structure, into a serialized structure (e.g., a file, a buffer stream, etc.). Similarly, the data may be deserialized from the serialized structure to obtain the original data. For example, a first client may serialize a data structure comprising one or more entities (e.g., portions of the data) into a buffer stream as a series of bits. A second client may access the buffer stream across a network connection, for example, and may perform a deserialization operation to access the entities within the buffer stream. In order to access the buffer stream, the second client may be validated by an access control technique (e.g., a username and password). Once validated, the second client may be granted access to obtain the buffer stream.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques for controlling an ability to serialize data into a serialized structure and/or to deserialize the serialized structure are provided herein. That is, access control may be enforced when serializing the data into the serialized structure (e.g., determining whether a client has permission to serialize one or more entities within the data). Similarly, access control may be enforced when data is deserialized from the serialized structure (e.g., determining whether a second client has permission to deserialize one or more entities from the serialized structure). In one example, access control may be incorporated into serialization/deserialization operations (e.g., access control may be incorporated into a serialized structure leveraging one or more of the aspects provided herein). It may be appreciated that a serialized structure may comprise a file, a buffer stream, and/or any structure that may comprise serialized data. In one example of creating a serialized structure, a client may request serialization of data into a serialized structure. The data may comprise one or more entities representing portions of the data. For example, if the data is associated with business records, then a first entity may represent a set of customer order records, a second entity may represent a set of billing history records, etc.

The data may be serialized into the serialized structure based upon whether the client has permission to serialize one or more entities within the data. That is, for respective entities within the data, a determination may be made as to whether the client has permission to serialize an entity (e.g., the client may be evaluated against a set of serialization permissions). If the client has permission to serialize the entity, then the entity may be serialized for inclusion within the serialized structure, otherwise the entity may not be serialized. For example, an online store server may request serialization of data comprising order status entities, employee social security number entities, and customer credit card entities. The online store server may have permission to serialize the order status entities and the customer credit card entities, but not the employee social security number entities. Accordingly, the order status entities and the customer credit card entities, but not the employee social security number entities, may be serialized for inclusion within the serialized structure. In this way, the serialized structure may be created, with data corresponding to entities selectively serialized therein.

Access control may be associated with the serialized structure (e.g., to prevent unauthorized access to one or more entities within the serialized structure). For example, the serialized structure may be encrypted using an encryption key unavailable to one or more clients (e.g., merely a serialization component and/or a deserialization component may have access to the encryption key). A set of deserialization permissions may be defined and/or associated with the serialized structure (e.g., embedded into the serialized structure; stored in a separate serialized structure; stored in a database accessible to a deserialization component; made available to clients interested in deserializing the serialized structure; etc.). For example, the set of deserialization permissions may specify that a billing server has permission to access the order status entities and the customer credit card entities within the serialized structure, and that an order status server may have permission to access the order status entities (e.g., but not the customer credit card entities) within the serialized structure.

In one example of controlling access to serialized data, a request from a client to access one or more entities included within a serialized structure may be received. The serialized structure may be deserialized based upon whether the client has permission to deserialize one or more entities within the serialized structure. That is, for respective entities within the serialized structure, a determination may be made as to whether the client has permission to deserialize an entity. For example, the client may be evaluated against a set of deserialization permissions (e.g., specified within the serialized structure, specified within a second serialized structure, specified within a permissions database and/or file, made available to the client and/or a deserialization component, etc.). If the client has permission to deserialize the entity, then the entity may be deserialized, otherwise the entity may not be deserialized. For example, order status entities (e.g., but not customer credit card entities) within the serialized structure may be deserialized for an order status server based upon evaluating the order status server against a set of deserialization permissions associated with the serialized structure. In this way, access control may be incorporated into serializing and/or deserializing data.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of serializing data.

FIG. 2 is a flow chart illustrating an exemplary method of controlling access to serialized data.

FIG. 3 is a component block diagram illustrating an exemplary system for serializing data.

FIG. 4 is an illustration of an example of serializing one or more entities within a data structure into a serialized structure.

FIG. 5 is an illustration of an example of a serialization component denying serialization of a data structure.

FIG. 6 is a component block diagram illustrating an exemplary system for controlling access to serialized data.

FIG. 7 is an illustration of an example of deserializing a serialized structure.

FIG. 8 is an illustration of an example of deserializing a serialized structure.

FIG. 9 is an illustration of an exemplary computer-readable medium wherein processor-executable instructions configured to embody one or more of the provisions set forth herein may be comprised.

FIG. 10 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Conventional data protection techniques generally verify whether a client has access rights to data, such as serialized data, before providing the data to the client. For example, a first client may serialize business records into a buffer stream made available over a network. A second client may desire to access the serialized business records within the buffer stream over the network. The second client may be unable to obtain/access the buffer stream without first verifying that the second client has permission to the buffer stream (e.g., the second client may submit a username/password before the buffer stream is made available to the second client). Once verified, the second client may obtain the buffer stream in an unprotected format, and may have unfettered access to all of the contents within the buffer stream. Unfortunately, conventional data protection techniques may not provide selective protection for particular entities within the buffer stream and/or may not provide sustained protection for the entities within the buffer stream after the client has obtained/accessed the buffer stream. Additionally, it is believed that conventional data protection does not provide a protection mechanism within the serialization/deserialization. Instead, data protection is merely provided external to serialization/deserialization operations.

Accordingly, one or more systems and/or techniques for selectively controlling an ability to serialize data into a serialized structure (e.g., selective protection in producing serialized data) and/or to selectively deserialize the serialized structure (e.g., selective protection of serialized data) are provided herein. That is, a first client may request serialization of data comprising one or more entities. Entities that the first client has permission to serialize may be serialized for inclusion within a serialized structure, but entities that the first client does not have permission to serialize may not be so serialized. To provide selective and sustained access control, the serialized structure may be encrypted and/or a set of deserialization permissions specifying what clients have permission to access particular entities within the serialized structure may be defined and/or associated with the serialized structure (e.g., accessible to a client interested in deserializing the serialized structure and/or a deserialization component). In this way, one or more entities within the serialized structure may (or may not) be deserialize for a second client based upon evaluating the second client against the set of deserialization permissions to determine which entities the second client has permission to deserialize/access.

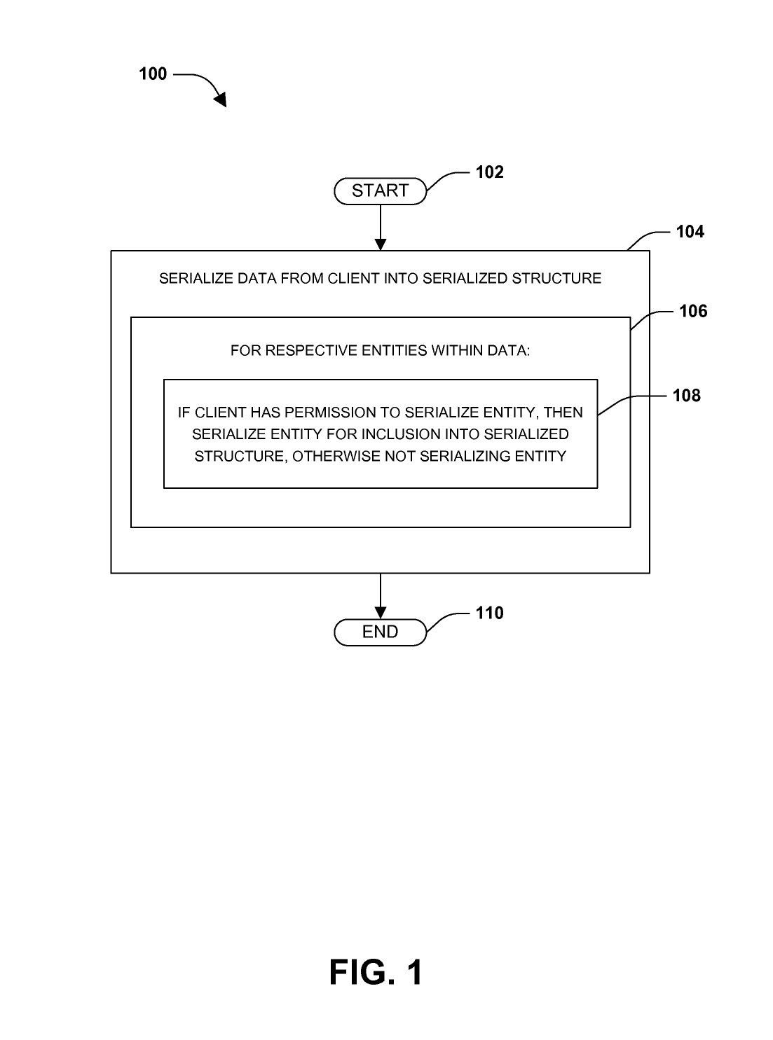

One embodiment of serializing data is illustrated by an exemplary method 100 if FIG. 1. At 102, the method starts. In one example, a client may request serialization of data comprising one or more entities. It may be appreciated that an entity may represent a portion of the data. In one example, if the data represents a programming data structure, then an entity may comprise a class entity, a nested class entity, a field entity, a subfield entity, etc. In another example, if the data represents business records, then an entity may represent one or more records (e.g., a first entity may represent billing records, a second entity may represent order history records, etc.).

At 104, the data may be serialized into the serialized structure based upon whether the client has permission to serialize one or more entities within the data. That is, for respective entities within the data, a determination may be made as to whether the client has permission to serialize an entity, at 106. At 108, if the client has permission to serialize the entity, then the entity may be serialized for inclusion into the serialized structure, otherwise the entity may not be serialized. In this way, the serialized structure may be created. The serialized structure may be encrypted to protect against unauthorized access to the serialized structure. For example, the serialized structure may be encrypted using an encryption key unavailable to one or more clients (e.g., the encryption key may be kept secret by a serialization component and/or a deserialization component). Thus, a client may obtain the serialized structure, but may be unable to access entities within the serialization structure without a grant of access (e.g., provided by a deserialization component). A set of deserialization permissions may be specified for the serialized structure (e.g., specified within the serialized structure; within a separate serialized structure; within a permissions database and/or file; etc.). A deserialization permission may specify which entities a client may have permission to deserialize/access within the serialized structure. Thus, one or more entities within the serialized structure may be deserialize for a client based upon evaluating the client against the set of deserialization permissions to determine which entities the client has permission to deserialize/access.

In one example of creating a serialized structure, a client may request serialization of a programming data structure comprising one or more class entities (e.g., and/or one or more subclass entities) and/or one or more field entities (e.g., and/or one or more subfield entities). The programming data structure may be associated with an object graph with which the one or more entities are associated. Accordingly, the programming data structure may be serialized during traversal of the object graph. For example, as entities are encounter during traversal of the object graph, a determination may be made as to whether the client has permission to serialize a current entity. In one example, if the client does not have permission to serialize a class entity, then the programming data structure may not be serialized (e.g., the serialization may result in an error because the remaining entities within the programming data structure may depend upon whether the class entity can be serialized). However, if the client does have permission to serialize the class entity, then the class entity may be serialized for inclusion within the serialized structure. In one example, one or more fields associated with the class may be evaluated for serialization. For example, if the client does not have permission to serialize a first field entity, then the first field entity may not be serialized. If the client has permission to serialize a second field entity, then the second field entity may be serialized. In this way, entities (e.g., class entities, subclass entities, field entities, subfield entities, etc.) that the client has permission to serialize may be serialized for inclusion within the serialized structure. The serialized structure may be encrypted and/or a set of deserialization permissions may be specified for and/or associated with the serialized structure.

A request to access the serialized structure may be received from a second client. For example, the second client may have obtained the serialized structure, but may be unable to access entities within the serialized structure because the serialized structure may be encrypted. Accordingly, the serialized structure may be decrypted and/or deserialized based upon evaluating the second client against the set of deserialization permissions. In this way, entities that the second client has permission to deserialize/access may be deserialized, while other entities may not be deserialized (e.g., a class entity may be deserialized, a first field entity may not be deserialized, and a second field entity may be deserialized). To provide sustained access control, the serialized structure may remain encrypted. At 110, the method ends.

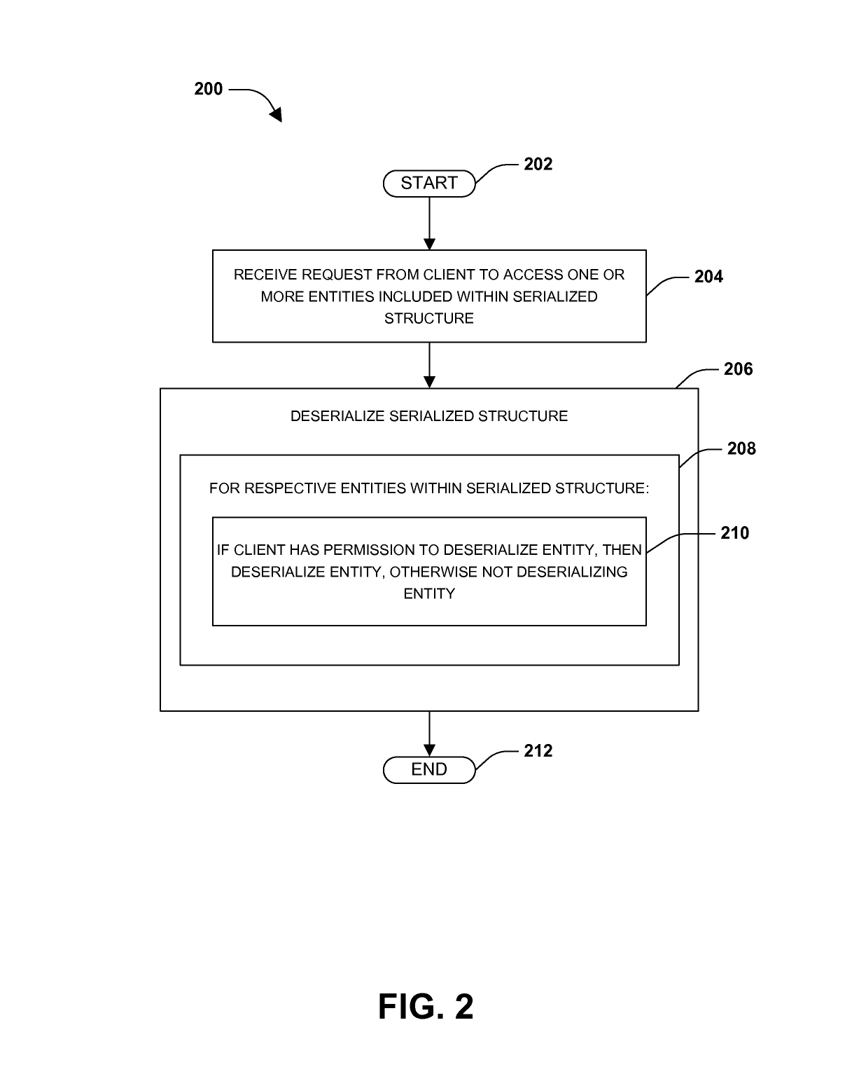

One embodiment of controlling access to serialized data is illustrated by an exemplary method 200 in FIG. 2. At 202, the method starts. At 204, a request from a client to access one or more entities included within a serialized structure may be received. For example, the client may have obtained the serialized structure, but may be unable to access the one or more entities included within the serialized structured (e.g., the serialized structure may have been encrypted with an encryption key unavailable to the client). At 206, the serialized structure may be deserialized based upon whether the client has permission to deserialize one or more entities within the serialized structure. That is, for respective entities within the serialized structure, a determination may be made as to whether the client has permission to deserialize an entity based upon evaluating the client against a set of deserialization permissions, at 208. At 210, if the client has permission to deserialize the entity, then the entity may be deserialized for the client, otherwise the entity may not be deserialized. In one example, the serialized structure may be decrypted during the deserialization using the encryption key unavailable to the client. It may be appreciated that in one example, after the deserialization has been perform, the serialized structure may remain encrypted (e.g., such that the client and/or other clients may be unable to access entities within the serialized structure).

In one example of deserializing a serialized structure, a client may request deserialization of a serialized structure comprising one or more entities (e.g., a class entity, a subclass entity, a field entity, a subfield entity, etc.) serialized from a programming data structure. The serialized structure may be associated with an object graph corresponding to the programming data structure. Accordingly, the serialized structure may be deserialized during a traversal of the object graph. For example, as entities are encountered during traversal of the object graph, a determination may be made as to whether the client has permission to deserialize a current entity. In one example, if the client does not have permission to deserialize a class entity, then the serialized structure may not be deserialized (e.g., the deserialization may result in an error because the remaining entities within the programming data structure may depend upon whether the class entity can be deserialized). However, if the client does have permission to deserialize the class entity, then the class entity may be deserialized for the client. In one example, one or more field entities may be encountered during the traversal. For example, if the client does not have permission to deserialize a first field entity, then the first field entity may not be deserialized. If the client does have permission to deserialize a second field entity, then the second field entity may be deserialized. In this way, entities that the client has permission to deserialize may be deserialized and/or made available to the client. It may be appreciated that in one example, the serialized structure may remain encrypted and/or entities within the serialized structure may be unavailable to one or more clients to provide sustained access control.

It may be appreciated that clients may be afforded varying levels of access to entities within the serialized structure based upon the set of deserialization permissions. For example, a first deserialization permission may specify that a first client may not have access to a first field entity, but may have access to a second field entity, while a second deserialization permission may specify that a second client may have access to the first field entity, but may not have access to the second field entity. In this way, access control to particular entities within the serialized structure may be tailored for various clients. At 212, the method ends.

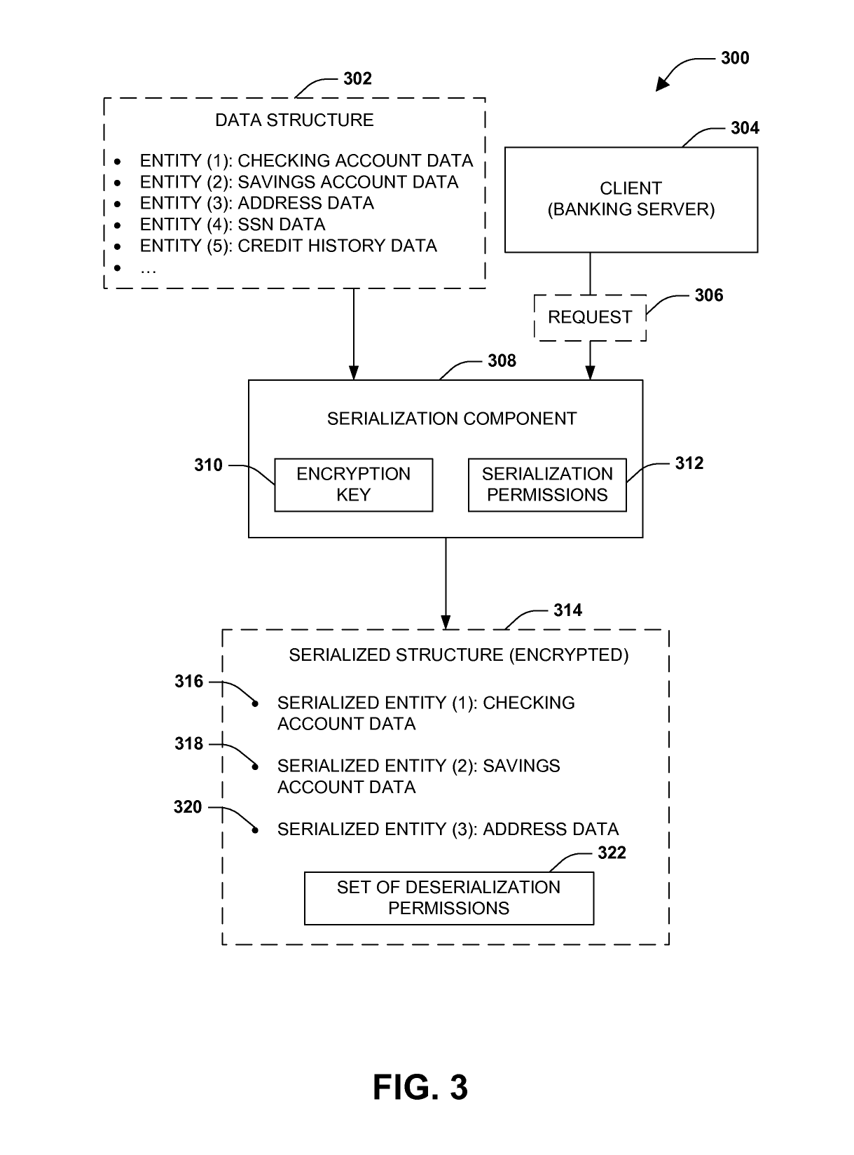

FIG. 3 illustrates an example of a system 300 configured for serializing data. The system 300 may comprise a serialization component 308. The serialization component 308 may be configured to serialize data into serialized structure 314. In one example, the serialization component 308 may receive a request 306 from a client banking server 304, for example, to serialize a data structure 302 comprising one or more entities (e.g., entity (1) may comprise checking account data, entity (2) may comprise savings account data, entity (3) may comprise address data, entity (4) may comprise social security number (SSN) data, entity (5) may comprise credit history data, etc.). The serialization component 308 may evaluate the client banking server 304 against serialization permissions 312 to determine which entities within the data structure 302 the client banking server 304 has permission to serialize/access. For example, a serialization permission may specify that the client banking server 304 has permission to serialize entity (1) checking account data, entity (2) savings account data, and entity (3) address data, but does not have permission to serialize entity (4) SSN data and entity (5) credit history data. It may be appreciated that varying levels of permissions may be specified for various clients (e.g., a second serialization permission may specify that a client billing server has permission to serialize the entity (5) comprising credit history data, but no other entities).

Accordingly, the serialization component 308 may serialize the entity (1) checking account data to create serialized entity (1) checking account data 316 for inclusion within the serialized structure 314. The serialization component 308 may serialize the entity (2) savings account data to create the serialized entity (2) savings account data 318 for inclusion within the serialized structure 314. The serialization component 308 may serialize the entity (3) address data to create serialized entity (3) address data 320 for inclusion within the serialized structure 316. A set of deserialization permissions 322 may be defined and/or associated with the serialized structure 314 (e.g., made available to clients interested in deserializing the serialized structure 314 and/or a deserialization component configured to deserialize the serialized structure). The set of deserialization permissions 322 may specify one or more permissions for clients to deserialize one or more serialized entities within the serialized structure 314. In one example, the serialized structure 314 may be encrypted using an encryption key 310 unavailable to the client banking server 304 and/or other clients no illustrated. In this way, sustained access control may be provided for the serialized structure 314 (e.g., even after a client obtains the serialized structure 314).

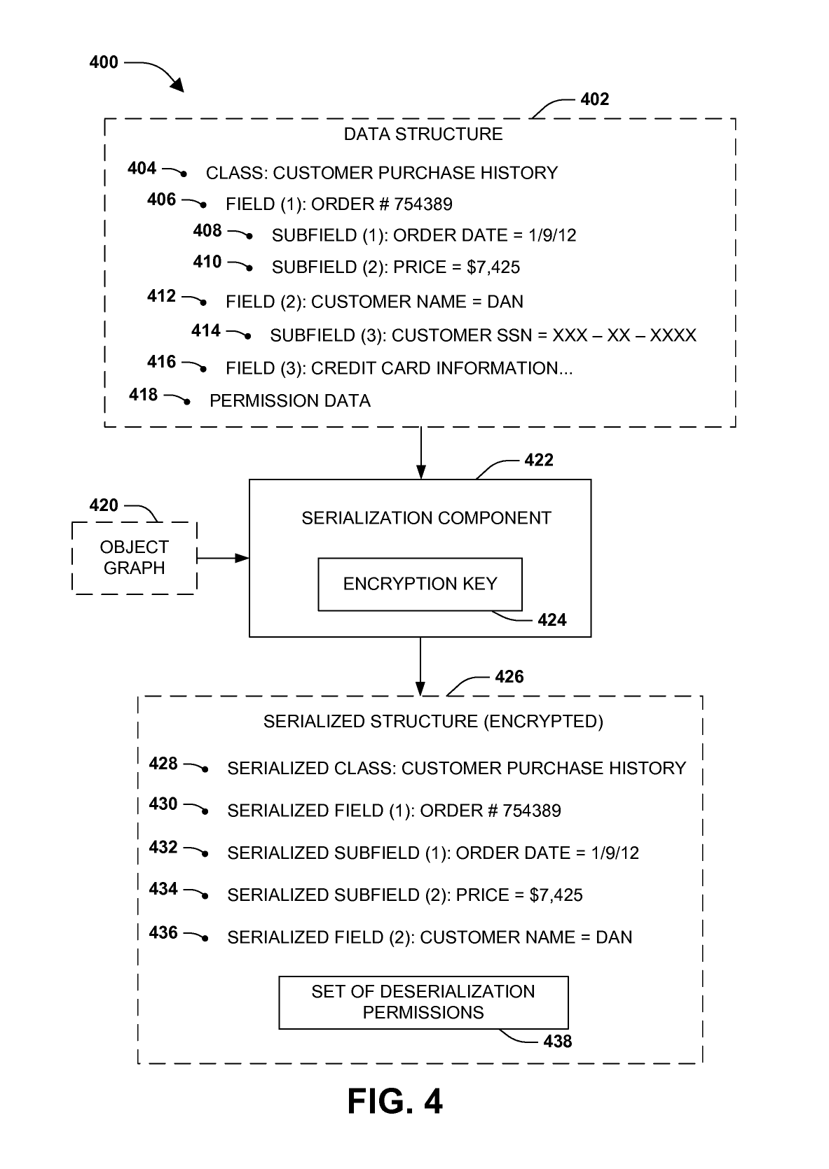

FIG. 4 illustrates an example 400 of serializing one or more entities within a data structure 402 into a serialized structure 426. In one example, a client may request serialization of the data structure 402 (e.g., a programming data structure associated with an object graph 420). The data structure 402 may comprise one or more entities associated with customer purchase history data. For example, a class entity 404 may comprise a customer purchase history class, a field entity (1) 406 may comprise an order number, a subfield entity (1) 408 may comprise an order date, a subfield entity (2) 410 may comprise a price, a field entity (2) 412 may comprise a customer name, subfield entity (3) 414 may comprise a customer SSN, and/or field entity (3) 416 may comprise credit card information. In one example, the data structure 402 may comprise permission data 418, which may be used by a serialization component 422 to specify a set of deserialization permissions 438 for the serialization structure 426.

The serialization component 422 may be configured to serialize the data structure 402 based upon a serialization permission associated with the client (e.g., during traversal of the object graph 420). For example, a serialization permission may specify that the client has permission to serialize the class entity 404, the field entity (1) 406, the subfield entity (1) 408, the subfield entity (2) 410, and/or the field entity (2) 412. However, the client may not have permission to serialize the subfield entity (3) 414 and/or the field entity (3) 416 (e.g., the client may correspond to a shopping website server that may have permission to access purchasing data, such as order information and some customer information, but not sensitive information, such as social security numbers and/or credit card information). In this way, the serialization component 422 may serialize the class entity 404 to create the serialized class entity 428, the field entity (1) 406 to create the serialized field entity (1) 430, the subfield entity (1) 408 to create the serialized subfield entity (1) 432, the subfield entity (2) 410 to create the serialized subfield entity (2) 434, and/or the field entity (2) 412 to create the serialized field entity (2) 436 for inclusion within the serialized structure 426. The serialization component 422 may associate the set of deserialization permissions 438 within the serialized structure 426. The serialization component 422 may encrypt the serialized structure 426 using an encryption key 424 unavailable to one or more clients to provide for sustained access control.

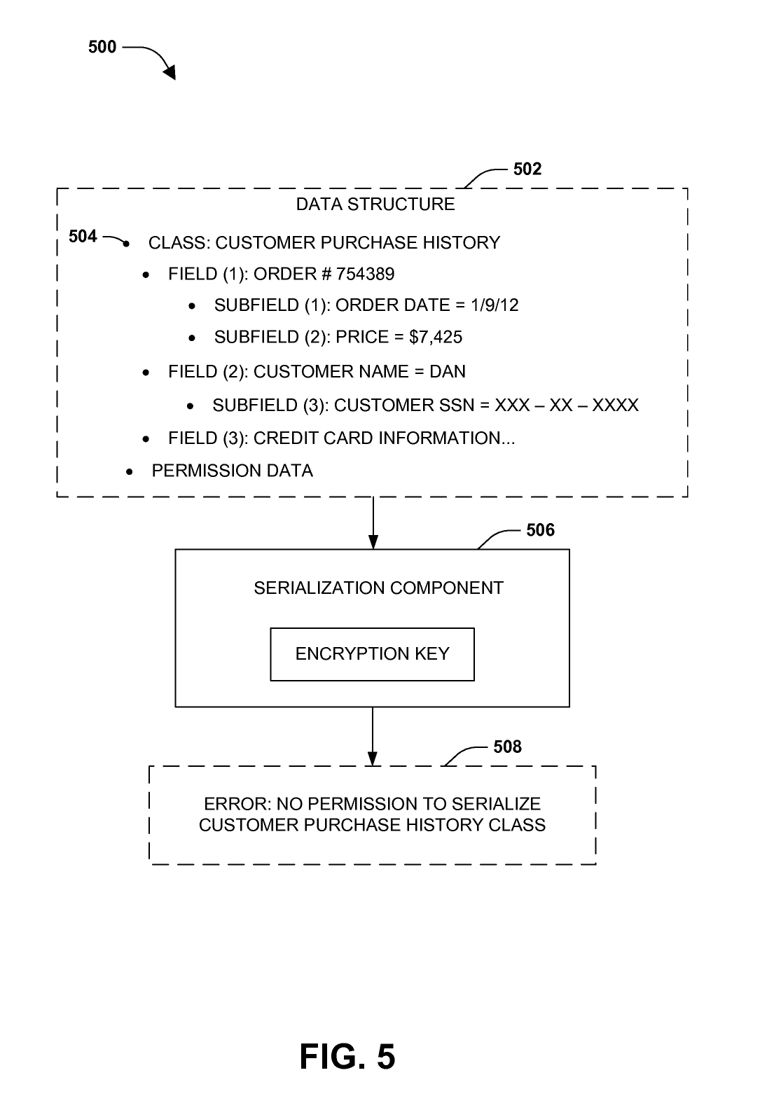

FIG. 5 illustrates an example 500 of a serialization component 506 denying serialization of a data structure 502. A client may request serialization of the data structure 502 comprising a class entity 504 and/or other entities. For example, an employee payroll server may request serialization of customer purchase history data. The serialization component 506 may be configured to serialize the data structure 502 for the client based upon whether the client has permission to serialize/access one or more entities within the data structure 502. The serialization component 506 may determine that the employee payroll server has permission to serialize payroll data, but lacks permission to serialize customer purchase history data, such as the class entity 504 comprising customer purchase history data. Accordingly, the serialization component 506 may deny 508 the serialization of the data structure 502 (e.g., serialization of other entities within the data structure 502 may depend upon whether the employee payroll server has permission to serialize the class entity 504).

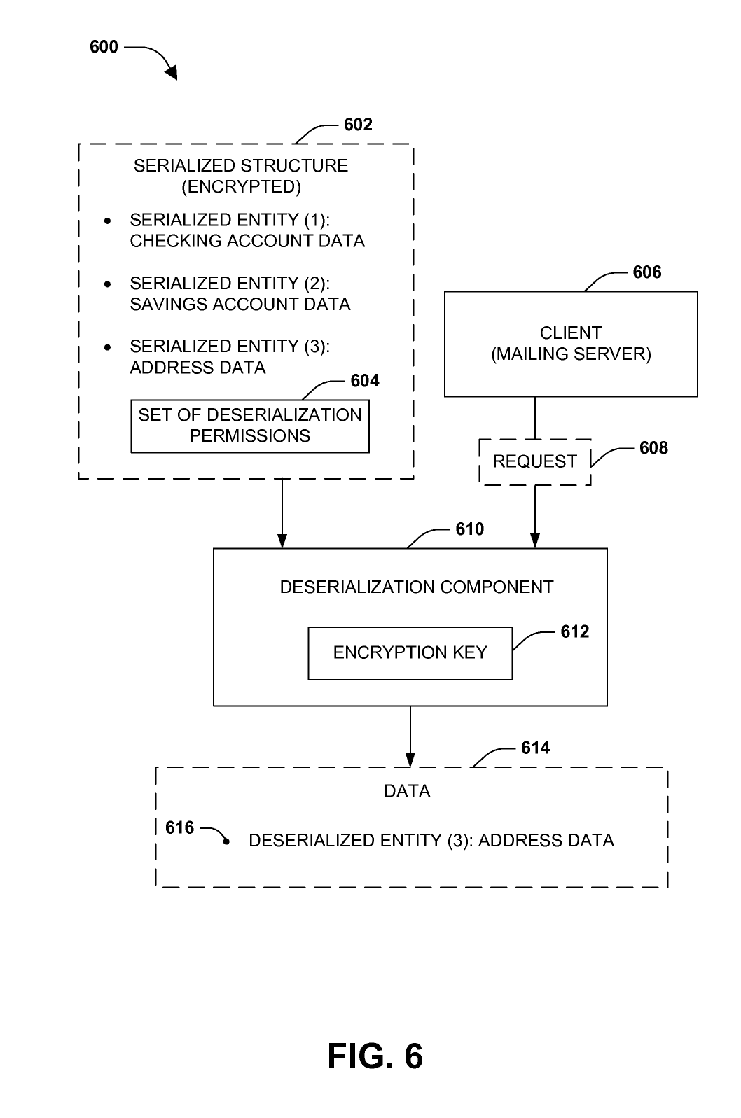

FIG. 6 illustrates an example of a system 600 configured for controlling access to serialized data. The system 600 may comprise a deserialization component 610. The deserialization component 610 may be configured to receive a request 608 from a client mailing server 606, for example, to deserialize a serialized structure 602. For example, the client mailing server 606 may have obtained the serialized structure 602, but may be unable to access entities within the serialized structure 602 because the serialized structure 602 may have been encrypted with an encryption key 612 unavailable to the client mailing server 606. The serialized structure 602 may comprise one or more entities, such as serialized entity (1) comprising checking account data, serialized entity (2) comprising savings account data, and/or serialized entity (3) comprising address data.

The serialized structure 602 may comprise a set of deserialization permissions 604, which may be used by the deserialization component 610 to deserialize entities within the serialized structure 602 that the client mailing server 606 has permission to deserialize. The set of deserialization permissions 604 may specify that the client mailing server 606 has permission to access address data, such as serialized entity (3) of address data, but does not have permission to access other data, such as serialized entity (1) of checking account data and/or serialized entity (2) of savings account data. Accordingly, the deserialization component 610 may decrypt the serialized structure 602 using the encryption key 612, and may deserialize the serialize entity (3) to create the deserialized entity (3) 616 of address data. However, the serialized entity (1) and the serialized entity (2) may not be deserialized because the client mailing server 606 does not have permission to deserialize such entities. The deserialized entity (3) 616 of address data may be made available to the client mailing server 606 as data 614. It may be appreciated that the serialized structure 602 may remain encrypted to provide sustained access control.

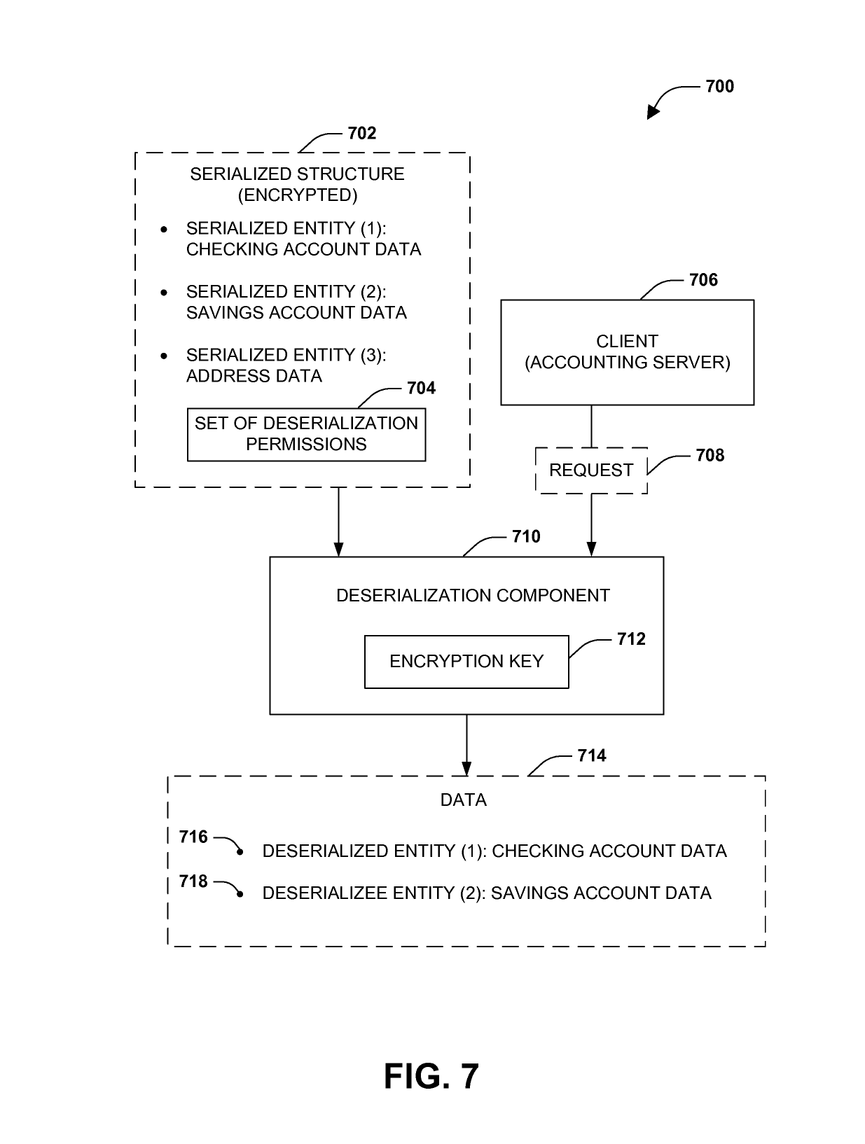

FIG. 7 illustrates an example 700 of deserializing a serialized structure 702. The system 700 may comprise a deserialization component 710. The deserialization component 710 may be configured to receive a request 708 from a client accounting server 706, for example, to deserialize the serialized structure 702. For example, the client accounting server 706 may have obtained the serialized structure 702, but may be unable to access the serialized structure 702 because the serialized structure 702 may have been encrypted with an encryption key 712 unavailable to the client accounting server 706. The serialized structure 702 may comprise one or more entities, such as serialized entity (1) comprising checking account data, serialized entity (2) comprising savings account data, and/or serialized entity (3) comprising address data.

The serialized structure 702 may comprise a set of deserialization permissions 704, which may be used by the deserialization component 710 to deserialize entities within the serialized structure 702 that the client accounting server 706 has permission to deserialize. It may be appreciated that in one example, the set of deserialization permissions 704 may specify varying levels of permissions for various clients (e.g., client accounting server 706 may have permission to access a different set of entities than client mailing server 606 of FIG. 6). The set of deserialization permissions 704 may specify that the client accounting server 706 has permission to access accounting data, such as serialized entity (1) of checking account data and serialized entity (2) of savings account data, but does not have permission to access other data, such as serialized entity (3) of address data. Accordingly, the deserialization component 710 may decrypt the serialized structure 702 using the encryption key 712, and may deserialize the serialize entity (1) to create the deserialized entity (1) 716 of checking account data and the deserialized entity (2) to create the deserialized entity (2) 718 of savings account data. However, the serialized entity (3) may not be deserialized because the client accounting server 706 does not have permission to deserialize such an entity. The deserialized entity (1) 716 of checking account data and/or the deserialized entity (2) 718 of savings account data may be made available to the client accounting server 706 as data 714. It may be appreciated that the serialized structure 702 may remain encrypted to provide sustained access control.

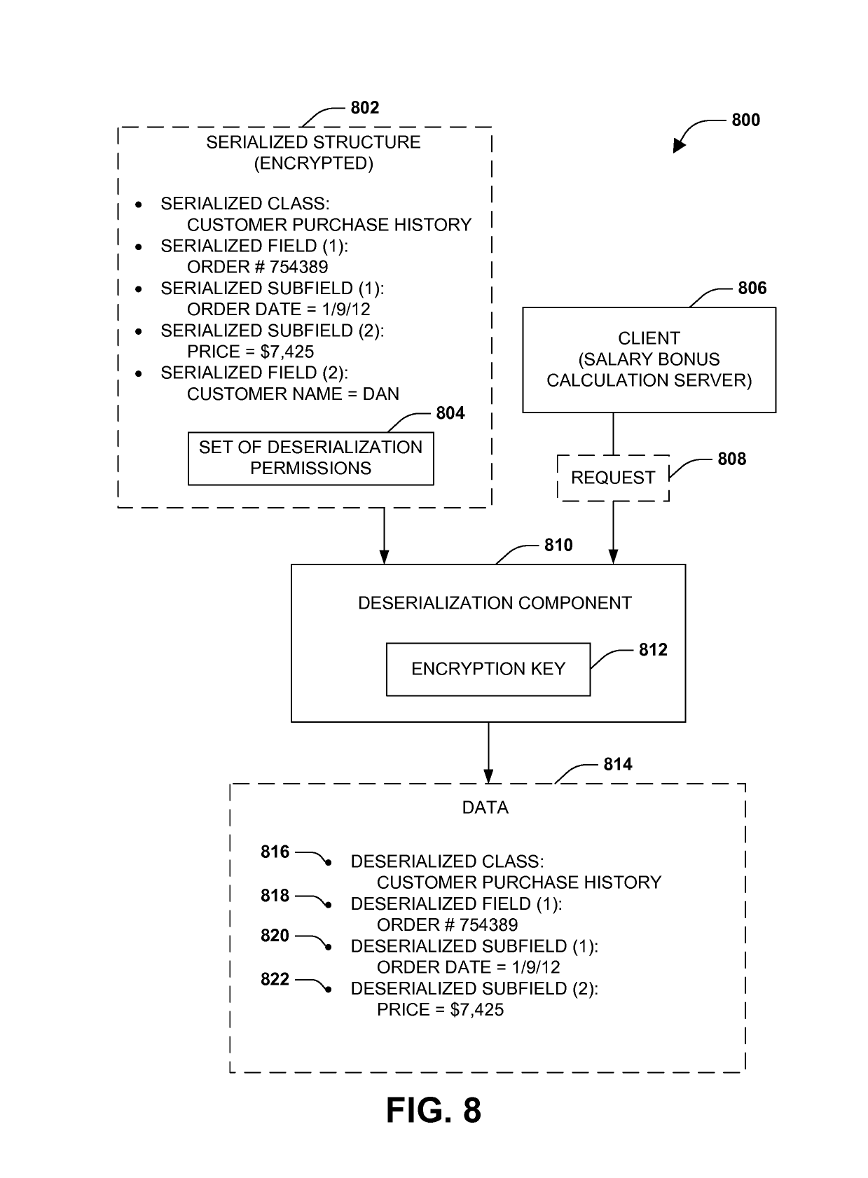

FIG. 8 illustrates an example 800 of deserializing a data structure 802. The system 800 may comprise a deserialization component 810. The deserialization component 810 may be configured to receive a request 808 from a client salary bonus calculation server 806, for example, to deserialize the serialized structure 802. For example, the client salary bonus calculation server 806 may have obtained the serialized structure 802, but may be unable to access the serialized structure 802 because the serialized structure 802 may have been encrypted with an encryption key 812 unavailable to the client salary bonus calculation server 806. The serialized structure 802 may comprise one or more entities, such as serialized class entity comprising a customer purchase history class, serialized field entity (1) comprising an order number, a serialized subfield entity (1) comprising an order date, a serialized subfield entity (2) comprising a price, and a serialized field entity (2) comprising a customer name.

The serialized structure 802 may comprise a set of deserialization permissions 804, which may be used by the deserialization component 810 to deserialize entities within the serialized structure 802 that the client salary bonus calculation server 806 has permission to deserialize. The set of deserialization permissions 804 may specify that the client salary bonus calculation server 806 has permission to access the serialized class, the serialized field (1), the serialized subfield (1), and the serialized subfield (2). However, the set of deserialization permissions may specify that the client salary bonus calculation server 806 does not have permission to access the serialized field (2) of the customer name. Accordingly, the deserialization component 810 may decrypt the serialized structure 802 using the encryption key 812, and may deserialize the serialized class entity to create the deserialized class entity 816, the serialized field entity (1) to create the deserialized field entity (1) 818, the serialized subfield entity (1) to create the deserialized subfield entity (1) 820, and the serialized subfield entity (2) to create the deserialized subfield entity (2) 822. However, the serialized field entity (2) may not be deserialized because the client salary bonus calculation server 806 does not have permission to deserialize such an entity. The deserialized class entity 816, the deserialized field entity (1) 818, the deserialized subfield entity (1) 820, and/or the deserialized subfield entity (2) 822 may be made available to the client salary bonus calculation server 806 as data 814. It may be appreciated that the serialized structure 802 may remain encrypted to provide sustained access control.

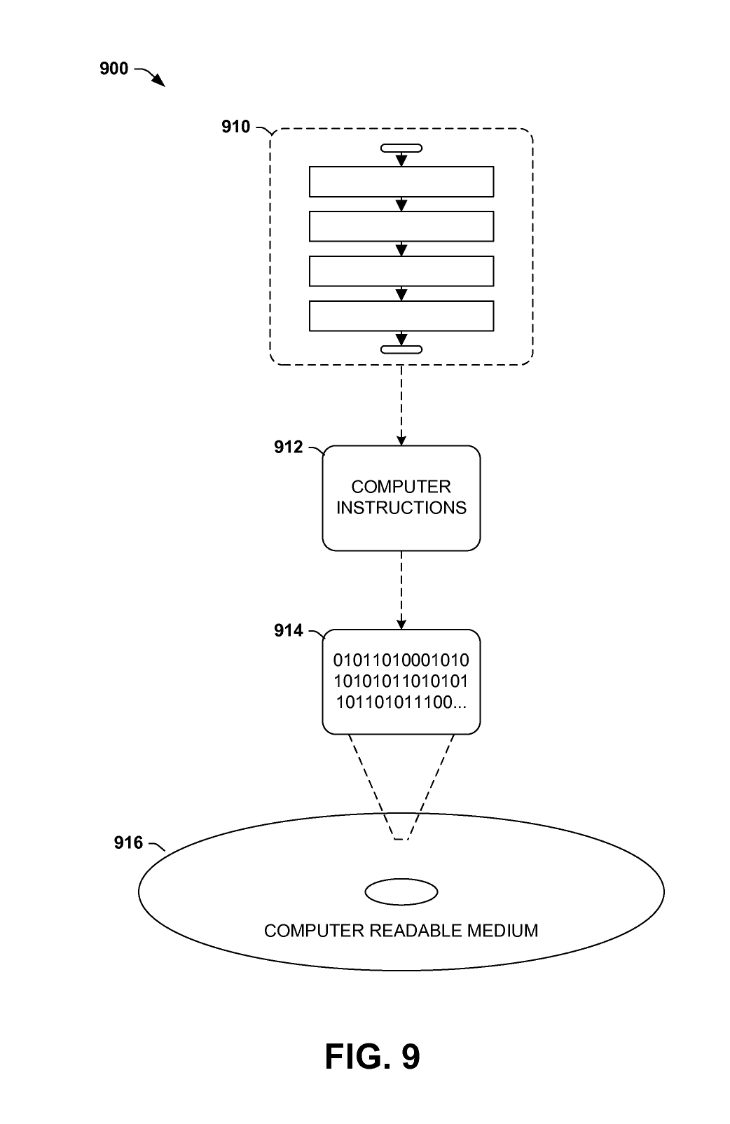

Still another embodiment involves a computer-readable medium comprising processor-executable instructions configured to implement one or more of the techniques presented herein. An exemplary computer-readable medium that may be devised in these ways is illustrated in FIG. 9, wherein the implementation 900 comprises a computer-readable medium 916 (e.g., a CD-R, DVD-R, or a platter of a hard disk drive), on which is encoded computer-readable data 914. This computer-readable data 914 in turn comprises a set of computer instructions 912 configured to operate according to one or more of the principles set forth herein. In one such embodiment 900, the processor-executable computer instructions 912 may be configured to perform a method 910, such as at least some of the exemplary method 100 of FIG. 1 and/or at least some of exemplary method 200 of FIG. 2, for example. In another such embodiment, the processor-executable instructions 912 may be configured to implement a system, such as at least some of the exemplary system 300 of FIG. 3 and/or at least some of the exemplary system 600 of FIG. 6, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

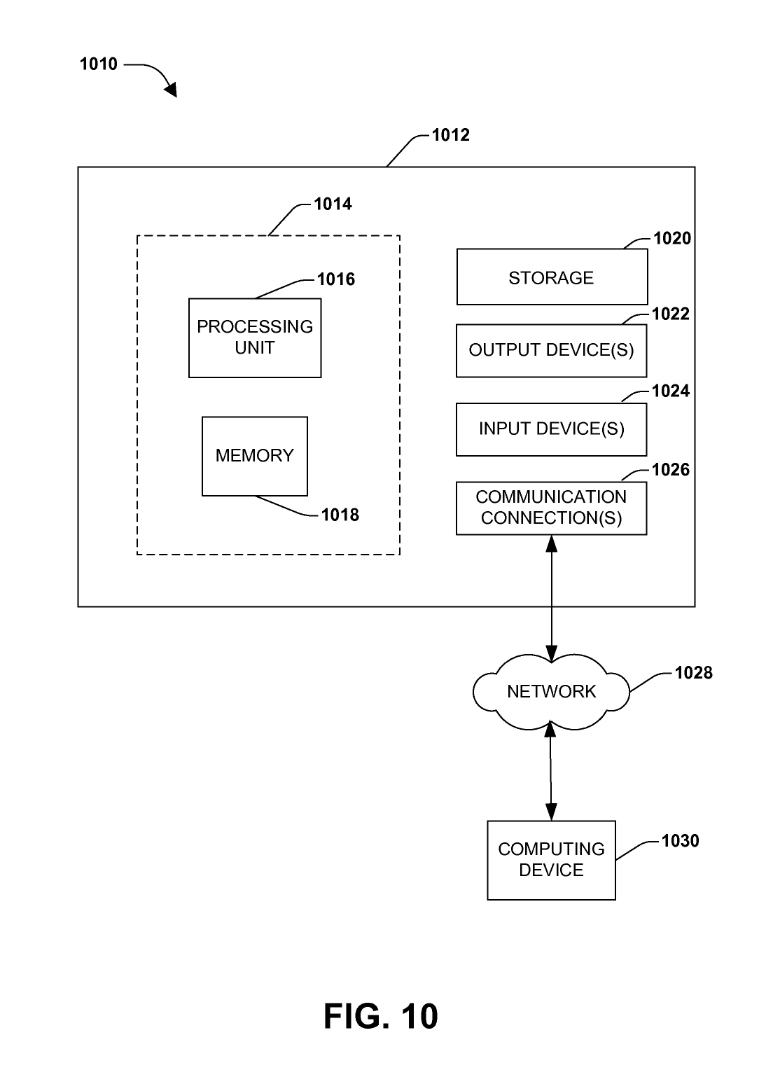

FIG. 10 and the following discussion provide a brief, general description of a suitable computing environment to implement embodiments of one or more of the provisions set forth herein. The operating environment of FIG. 10 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 1010 comprising a computing device 1012 configured to implement one or more embodiments provided herein. In one configuration, computing device 1012 includes at least one processing unit 1016 and memory 1018. Depending on the exact configuration and type of computing device, memory 1018 may be volatile (such as RAM, for example), non-volatile (such as ROM, flash memory, etc., for example) or some combination of the two. This configuration is illustrated in FIG. 10 by dashed line 1014.

In other embodiments, device 1012 may include additional features and/or functionality. For example, device 1012 may also include additional storage (e.g., removable and/or non-removable) including, but not limited to, magnetic storage, optical storage, and the like. Such additional storage is illustrated in FIG. 10 by storage 1020. In one embodiment, computer readable instructions to implement one or more embodiments provided herein may be in storage 1020. Storage 1020 may also store other computer readable instructions to implement an operating system, an application program, and the like. Computer readable instructions may be loaded in memory 1018 for execution by processing unit 1016, for example.

The term “computer readable media” as used herein includes computer storage media. Computer storage media includes volatile and nonvolatile, removable and non-removable media implemented in any method or technology for storage of information such as computer readable instructions or other data. Memory 1018 and storage 1020 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1012 may include input device(s) 1024 such as keyboard, mouse, pen, voice input device, touch input device, infrared cameras, video input devices, and/or any other input device. Output device(s) 1022 such as one or more displays, speakers, printers, and/or any other output device may also be included in device 1012. Input device(s) 1024 and output device(s) 1022 may be connected to device 1012 via a wired connection, wireless connection, or any combination thereof. In one embodiment, an input device or an output device from another computing device may be used as input device(s) 1024 or output device(s) 1022 for computing device 1012.

Components of computing device 1012 may be connected by various interconnects, such as a bus. Such interconnects may include a Peripheral Component Interconnect (PCI), such as PCI Express, a Universal Serial Bus (USB), firewire (IEEE 13104), an optical bus structure, and the like. In another embodiment, components of computing device 1012 may be interconnected by a network. For example, memory 1018 may be comprised of multiple physical memory units located in different physical locations interconnected by a network.

Those skilled in the art will realize that storage devices utilized to store computer readable instructions may be distributed across a network. For example, a computing device 1030 accessible via a network 1028 may store computer readable instructions to implement one or more embodiments provided herein. Computing device 1012 may access computing device 1030 and download a part or all of the computer readable instructions for execution. Alternatively, computing device 1012 may download pieces of the computer readable instructions, as needed, or some instructions may be executed at computing device 1012 and some at computing device 1030.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

1. A method, comprising:
serializing data from a client into a serialized structure, the serializing comprising:
for respective entities within the data:
determining whether the client has permission to serialize an entity, and if the client has permission, then serializing the entity for inclusion in the serialized structure, otherwise not serializing the entity.

2. The method of claim 1, the serializing data from a client comprising:
traversing an object graph with which one or more entities within the data are associated.

3. The method of claim 1, an entity comprising at least one of:
a class entity;
a nested class entity;
a field entity; and
a subfield entity.

4. The method of claim 1, the data associated with an instance of a class, and the determining whether the client has permission to serialize an entity comprising:
determining whether the client has permission to serialize a class entity, and if the client has permission, then serializing the class entity for inclusion in the serialized structure, otherwise not serializing the data.

5. The method of claim 1, the determining whether the client has permission to serialize an entity comprising:
determining whether the client has permission to serialize a field entity, and if the client has permission, then serializing the field entity for inclusion in the serialized structure, otherwise not serializing the field entity.

6. The method of claim 1, the determining whether the client has permission to serialize an entity comprising:
upon determining the client does not have permission to serialize a first field entity, then not serializing the first field entity; and
upon determining the client has permission to serialize a second field entity, then serializing the second field entity for inclusion in the serialized structure.

7. The method of claim 1, comprising:
specifying a set of deserialization permissions within the serialized structure.

8. The method of claim 1, comprising:
encrypting the serialized structure using an encryption key unavailable to one or more clients.

9. The method of claim 1, comprising:
receiving a request to access the serialized structure from a second client;
deserializing the serialized structure, the deserializing comprising:
for respective entities included within the serialized structure:
determining whether the second client has permission to deserialize an entity based upon evaluating the second client against a set of deserialization permissions, and if the second client has permission, then deserializing the entity for the second client, otherwise not deserializing the entity.

10. The method of claim 9, the determining whether the second client has permission to deserialize the entity comprising:
upon determining the second client does not have permission to deserialize a first field entity, then not deserializing the first field entity; and
upon determining the second client does have permission to deserialize a second field entity, then deserializing the second field entity for the second client.

11. A method for controlling access to serialized data, comprising:
receiving a request from a client to access one or more entities included within a serialized structure;
deserializing the serialized structure, the deserializing comprising:
for respective entities included within the serialized structure:
determining whether the client has permission to deserialize an entity based upon evaluating the client against a set of deserialization permissions, and if the client has permission, then deserializing the entity for the client, otherwise not deserializing the entity.

12. The method of claim 11, the deserializing comprising:
traversing an object graph with which one or more entities included within the serialized structure are associated.

13. The method of claim 11, the determining whether the client has permission to deserialize the entity comprising:
upon determining the client does not have permission to deserialize a first field entity, then not deserializing the first field entity; and
upon determining the client does have permission to deserialize a second field entity, then deserializing the second field entity for the client.

14. The method of claim 13, comprising:
receiving a second request to access one or more entities included within the serialized structure from a second client;
deserializing the serialized structure for the second client, comprising:
upon determining the second client does have permission to deserialize the first field entity, then deserializing the first field entity for the second client; and
upon determining the second client does not have permission to deserialize the second field entity, then not deserializing the second field entity.

15. The method of claim 11, the deserializing comprising:
decrypting the serialized structure using an encryption key unavailable to the client.

16. (canceled)

16. A system, comprising:
a serialization component configured to:
serialize data from a client into a serialized structure, comprising:
for respective entities within the data:
determine whether the client has permission to serialize an entity, and if the client has permission, then serialize the entity for inclusion in the serialized structure, otherwise not serializing the entity.

17. The system of claim 16, the serialization component configured to at least one of:
define a set of deserialization permissions for the serialized structure; and
encrypt the serialized structure using an encryption key unavailable to one or more clients.

18. The system of claim 16, comprising:
a deserialization component configured to:
receive a request to access the serialized structure from a second client;
deserialize the serialized structure, the deserializing comprising:
for respective entities included within the serialized structure:
determine whether the second client has permission to deserialize an entity based upon evaluating the second client against a set of deserialization permission, and if the second client has permission, then deserialize the entity for the second client, otherwise not deserializing the entity.

19. The system of claim 18, the deserialization component configured to:
upon determining the second client does not have permission to deserialize a first field entity, then not deserializing the first field entity; and
upon determining the second client does have permission to deserialize a second field entity, then deserializing the second field entity for the second client.

20. The system of claim 19, the deserialization component configured to:
receive a second request to access one or more entities included within the serialized structure from a third client;
deserialize the serialized structure for the third client, comprising:
upon determining the third client does have permission to deserialize the first field entity, then deserializing the first field entity for the third client; and
upon determining the third client does not have permission to deserialize the second field entity, then not deserializing the second field entity.
